(19) United States
(12) Patent Application Publication
(10) Pub. No.: US 2025/0199159 A1
(43) Pub. Date: Jun. 19, 2025

(54) Comprehensive Reconnaissance System for Photoelectric Radar

(71) Applicant: Beijing Institute of Aerospace Control Devices, Beijing (CN)

(72) Inventors: Shaopeng Liu, Beijing (CN); Na Zhu, Beijing (CN); Yachuan Wei, Beijing (CN)

(21) Appl. No.: 18/847,392

(22) PCT Filed: Dec. 24, 2022
(86) PCT No.: PCT/CN2022/141709

§ 371 Date: Sep. 16, 2024

(30) Foreign Application Priority Data
Mar. 17, 2022 (CN) 202210265427.9

(51) Int. Cl. G01S 13/86; G01S 7/02; G01S 7/22; G01S 7/40; G01S 13/68; G01S 13/89

(52) U.S. Cl. CPC G01S 13/867; G01S 7/027; G01S 7/22; G01S 7/4004; G01S 13/68; G01S 13/865; G01S 13/89

(57) ABSTRACT

A comprehensive reconnaissance system for a photoelectric radar, comprising an electronic cabin, a cantilever, and a load cabin. The load cabin is mounted on the side wall of the electronic cabin by means of the cantilever, and the load cabin is electrically connected to the electronic cabin; a visible light camera, an infrared thermographic camera, a laser measuring and illuminating device, and a radar are arranged in the load cabin; an image processing module, a data processing module, an image fusion module, an image compression module, and a platform control drive module are arranged in the electronic cabin. The system can realize reconnaissance in a radar multi-source reconnaissance mode, a collaborative search reconnaissance mode, and a moving target detection and heterosource video fusion reconnaissance mode.

### CROSS-REFERENCE TO RELATED APPLICATION

This application is a US national phase application of International Application No. PCT/CN2022/141709, filed on Dec. 24, 2022, which claims a priority of Chinese Patent Application filed with the China Patent Office on Mar. 17, 2022, with the application Serial No. 202210265427.9, and titled “system for photoelectric radar comprehensive reconnaissance”, the content of which is incorporated herein by reference in its entirety.

### FIELD

The present disclosure belongs to the field of aerial reconnaissance technology, and relates to a system for photoelectric radar comprehensive reconnaissance.

### BACKGROUND

Airborne reconnaissance equipment is a payload installed on an unmanned or manned aerial vehicle, which can effectively perform reconnaissance on targets. At present, a reconnaissance platform has separate payloads for an optoelectronic reconnaissance platform and a radar reconnaissance platform.

### SUMMARY

A system for photoelectric radar comprehensive reconnaissance includes an electronics cabin, a cantilever and a load cabin; the load cabin is installed on a side wall of the electronics cabin through the cantilever, and the load cabin is electrically coupled to the electronics cabin; the load cabin is provided with a visible light camera, an infrared thermal imager, a laser rangefinder and a radar therein; the electronics cabin is provided with an image processing module, a data processing module, an image fusion module, an image compression module and a platform control and driver module therein.

When the reconnaissance system is in a radar multi-source reconnaissance mode,
the visible light camera, performs image sampling, obtains a visible light image signal, and sends the visible light image signal to the image processing module;
the infrared thermal imager, performs image sampling, obtain an infrared image signal, and sends the infrared image signal to the image processing module;
the laser rangefinder, measures a distance value between the load cabin and a target, and sends the distance value to the image processing module;
the image processing module, receives the distance value from the laser rangefinder, receives the visible light image signal from the visible light camera, receives the infrared image signal from the infrared thermal imager, and performs geometric correction on the visible light image signal and the infrared image signal to generate a corrected optical image, and sends the corrected optical image to the image fusion module;
the radar, performs echo data sampling and sends echo data to the data processing module;
the data processing module, receives the echo data from the radar, converts the echo data into a radar image, performs geometric correction on the radar image to generate a corrected radar image, and sends the corrected radar image to the image fusion module, and obtains a load cabin adjustment angle according to the corrected radar image, and sends the load cabin adjustment angle to the platform drive module;
the platform control and drive module, receives the load cabin adjustment angle from the data processing module, and drives, according to the load cabin adjustment angle, the cantilever to rotate the load cabin to aim at the target;
the image fusion module, receives the corrected optical image from the image processing module, receives the corrected radar image from the data processing module, performs image registration and fusion processing on the corrected optical image and the corrected radar image in sequence, obtain an original image, and send the original image to the image compression module;
the image compression module, receives the original image from the image fusion module, compresses the original image, generates a compressed image, and downloads the compressed image to an external ground station.

### BRIEF DESCRIPTION OF THE DRAWINGS

FIG. 1 is a schematic diagram illustrating an overall of a reconnaissance system of the present disclosure.

FIG. 2 is a schematic diagram illustrating a radar multi-source reconnaissance mode of a system of the present disclosure.

FIG. 3 is a schematic diagram illustrating in a collaborative search reconnaissance mode of a system of the present disclosure.

FIG. 4 is a schematic diagram illustrating a moving target detection and heterosource video fusion reconnaissance mode of a system of the present disclosure.

### DETAILED DESCRIPTION

Airborne reconnaissance equipment is a payload installed on an unmanned or manned aerial vehicle, which can effectively perform reconnaissance on targets. At present, a reconnaissance platform has separate payloads for an optoelectronic reconnaissance platform and a radar reconnaissance platform. For an optoelectronic reconnaissance equipment, there are problems such as short operational distance and imaging that is easily affected by weather. For a radar reconnaissance equipment, there is the problem that imaging is difficult to interpret. Therefore, for medium and short-range unmanned aerial vehicles with requirements on weight, a photoelectric radar comprehensive reconnaissance equipment can be formed by integrating photoelectric sensors and radar sensors in a pod, which can solve the existing problem that photoelectric reconnaissance equipment and the radar reconnaissance equipment cannot be loaded simultaneously, realize reconnaissance support capabilities in all-day, all-weather and complex environments by utilizing complementary advantages of different reconnaissance means, and achieve higher reconnaissance capabilities within a limited volume.

Radar images have characteristics of a wide imaging size at once and a long imaging distance, up to 25 km or more, and a small impact from atmospheric visibility, but have disadvantage of imaging as black and white images without color information, rendering that the images generated have a significant difference from human visual perception, with a certain degree of difficulty in interpretation.

The present disclosure will be further described below in combination with embodiments.

The present disclosure a system for photoelectric radar comprehensive reconnaissance, which belongs to the technical field of aerial reconnaissance, capable of realizing reconnaissance in a plurality of modes such as a radar multi-source reconnaissance mode, a collaborative search reconnaissance mode, a moving target detection and heterosource video fusion reconnaissance mode. The present disclosure organically combines radar reconnaissance and optical sensor reconnaissance, realizes complementary advantages of different reconnaissance means, and has reconnaissance support capabilities in all-day, all-weather and complex environments.

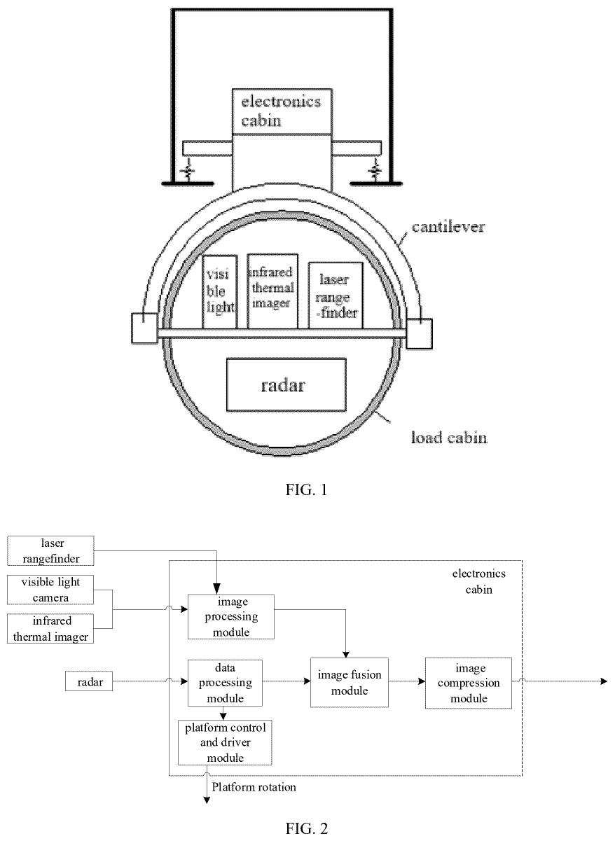

The system for photoelectric radar comprehensive reconnaissance, as shown in FIG. 1, specifically includes an electronics cabin, a cantilever and a load cabin; the load cabin is installed on a side wall of the electronics cabin through the cantilever, and the load cabin is electrically coupled to the electronics cabin; the load cabin is provided with a visible light camera, an infrared thermal imager, a laser rangefinder and a radar therein; the electronics cabin is provided with an image processing module, a data processing module, an image fusion module, an image compression module and a platform control and driver module therein.

An optical axis parallelism of the visible light camera, the infrared thermal imager, and the laser rangefinder is calibrated and maintained within 0.2 mrad. A parallelism between a beam direction of the radar and a visual axis of the optical sensor is less than 0.5°, enabling acquisition of information in the same target area and performing the multi-source imaging reconnaissance, the collaborative search reconnaissance and the moving target detection and heterosource video fusion reconnaissance mode.

As shown in FIG. 2, when the reconnaissance system is in radar multi-source reconnaissance mode, followings are provided.

The visible light camera performs image sampling, obtains a visible light image signal, and sends the visible light image signal to the image processing module.

The infrared thermal imager performs image sampling, obtain an infrared image signal, and sends the infrared image signal to the image processing module;

The laser rangefinder measures a distance value between the load cabin and a target, and sends the distance value to the image processing module.
the image processing module, receives the distance value from the laser rangefinder, receives the visible light image signal from the visible light camera, receives the infrared image signal from the infrared thermal imager, and performs geometric correction on the visible light image signal and the infrared image signal to generate a corrected optical image, and sends the corrected optical image to the image fusion module;

The radar performs echo data sampling and sends echo data to the data processing module.

The data processing module, receives the echo data from the radar, converts the echo data into a radar image, performs geometric correction on the radar image to generate a corrected radar image, and sends the corrected radar image to the image fusion module, and obtains a load cabin adjustment angle according to the corrected radar image, and sends the load cabin adjustment angle to the platform drive module.

The platform control and drive module receives the load cabin adjustment angle from the data processing module, and drives, according to the load cabin adjustment angle, the cantilever to rotate the load cabin to aim at the target.

The image fusion module receives the corrected optical image from the image processing module, receives the corrected radar image from the data processing module, performs image registration and fusion processing on the corrected optical image and the corrected radar image in sequence, obtain an original image, and send the original image to the image compression module.

The image compression module receives the original image from the image fusion module, compresses the original image, generates a compressed image, and downloads the compressed image to an external ground station.

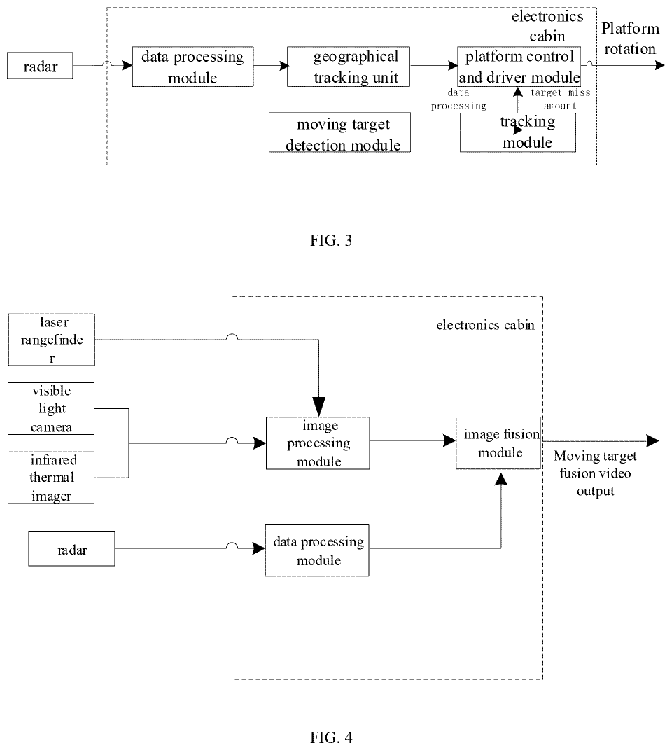

The electronics cabin is also provided with a geographical tracking unit, a tracking module and a moving target detection module. As shown in FIG. 3, when the reconnaissance system is in a collaborative search reconnaissance mode, followings are provided.

The radar performs echo data sampling and sends echo data to the data processing module.

The data processing module receives the echo data from the radar, performs parsing processing on the echo data, obtains plots and tracks data of a target, and sends the plots and tracks data of the target to the geographical tracking unit.

The geographic tracking unit receives the plots and tracks data of the target from the data processing module, obtains a load cabin adjustment angle by parsing based on the plots and tracks data of the target and its own pose information, and sends the load cabin adjustment angle to the platform control and drive module.

The platform control and drive module receives the load cabin adjustment angle from the geographical tracking unit, drives, according to the load cabin adjustment angle, the cantilever to rotate the load cabin to aim at the target, and receives a target miss angle from the tracking module, and drives, according to the target miss angle, the cantilever to rotate the load cabin, to aim at and track a target area, thus achieving collaborative search.

The moving target detection module after receiving a moving target detection turning-on indication, measures a target offset and send the target offset to the tracking module.

The tracking module receives the target offset from the moving target detection module, parsing the target offset to obtain the target miss angle, and sends the target miss angle to the platform control and drive module.

As shown in FIG. 4, when the reconnaissance system is in a moving target detection and heterosource video fusion reconnaissance mode, followings are provided.

The visible light camera performs image sampling, obtains a visible light video signal, and sends the visible light video signal to the image processing module.

The infrared thermal imager performs image sampling, obtains an infrared video signal, and sends the infrared video signal to the image processing module.

The laser rangefinder measures a distance value between the load cabin and a target, and sends the distance value to the image processing module.

The image processing module receives the distance value from the laser rangefinder, receives the visible light video signal from the visible light camera, receives the infrared video signal from the infrared thermal imager, positioning the visible light video signal and infrared video signal according to the distance value and its own pose information to obtain an optical video with positioning information, and send the optical video with positioning information to the image fusion module.

The radar performs echo data sampling and sending echo data to the data processing module.

The data processing module receives the echo data from the radar, performs echo data processing on the echo data, generates plots and tracks data of the target, and sends the plots and tracks data of the target to the image fusion module.

The image fusion module receives the optical video with positioning information from the image processing module, receives the plots and tracks data from the data processing module, performs registration and fusion processing on the optical video with positioning information with the plots and tracks data, to obtain a video superimposed with moving target information, completing moving target detection and heterosource video fusion reconnaissance.

The multi-source imaging reconnaissance mode refers to that a servo action of the cantilever is controlled by the radar, and the radar is in a strip mode, adjusts an optical field of view, and obtains an image of a target area for fusion.

The cooperative search reconnaissance mode refers to that a load is first in a GMTI (ground moving target indication) operation mode, selects the target, guides photoelectric to point to the target, and detects and tracks the target.

The moving target detection and heterosource video fusion reconnaissance mode is to label plots and tracks of the radar GMTI on the optical video to improve readability of the moving target.

The compressed image is in a format of JPEG.

### Embodiment

The optical axis parallelism of the visible light camera, the infrared thermal imager, and the laser rangefinder may be calibrated and maintained within 0.2 mrad. A structural design ensures that the beam direction of the radar is parallel to a visual axis of a photoelectric reconnaissance equipment, which may ensure that a parallelism between an antenna of the radar and the optical sensor is less than 0.5°.

### (1) Multi-Source Imaging Reconnaissance Mode

In order to obtain heterosource images of equal resolution for a largest scene, it is necessary to obtain the heterosource images simultaneously. Based on characteristics of a delay in radar image acquisition and block processing of real-time image fusion processing, an acquisition time point of original data of a center area in azimuth of the radar image is used as a time point when other image sensors acquire images, so that the three types of heterosource images have characteristics of the same area and the same visual axis, enabling simultaneous acquisition of images. The field of view of the photoelectric sensor is designed according to an effective distance of the radar, and equal resolution fusion is achieved after interpolation.

Two implementations are designed for the image fusion mode within the payload. One is a combination of the strip mode of the radar and photoelectric photography, and the other is a combination of a focused beam mode of the radar and the photoelectric photography.

In the combination of the strip mode of the radar and the photoelectric photography, the radar is in the strip mode, and the servo is controlled by the radar to adjust the optical field of view and obtain the image of the target area for fusion.

In the combination of the focused beam mode of the radar and the photoelectric photography, the radar is in focused beam mode and the servo is controlled by the radar. Due to a limitation of a radar beam width of the radar, it is difficult to meet an azimuth width, the radar is in the strip mode at different oblique angles of view. Stability of an inertial space of an azimuth beam is achieved by means of azimuth phase sweep compensation.

### (2) Collaborative Search Reconnaissance Mode

In the collaborative search reconnaissance mode, the photoelectric radar comprehensive reconnaissance equipment is first in a radar GMTI operation mode, selects a suspicious target, guides the photoelectric to point to the target, and detects and tracks the target.

The collaborative search reconnaissance mode refers to that the photoelectric radar comprehensive reconnaissance equipment is first in the GMTI operation mode and outputs the plots and tracks information of the target. The plots and tracks information includes a target number, geographical location information and speed information of the target. The plots and tracks information is sent to an image processor. The image processor, based on a moving target point designated by a task, as well as the geographical location information of the target at current time, estimates current position information of the target according to a speed of the target, and then adjusts the servo platform causing the photoelectric radar comprehensive reconnaissance equipment to point to the geographical location of the target, and performs geographical tracking, turns on moving target detection, automatically detects the moving target within the optical field of view, and selectively tracks the moving target within the field of view as needed. Since in the collaborative search reconnaissance mode, photoelectric pointing is coaxial with a radar beam normal, a maximum recognition capability of the photoelectric sensor is 8 km, and the radar beam width for downward and upward is about 3.8°. A distance section within 8 km covers about 1.2 km (typical aircraft height is 3 km). Under a condition that an error of an inertial navigation system is about 0.12°, an azimuth error generated at 8 km is within about 28 m; after establishing the track, the azimuth error generated at 8 km is within about 38 m. A distance measurement accuracy in a distance direction can reach 2 m, so an accuracy of radar moving target detection is within the field of view of the optical sensor. In the collaborative search reconnaissance mode, when the servo platform transfers to a designated target based on moving target information given by the radar, it adjusts the field of view of the optical sensor to ensure that the target is within the field of view of the photoelectric sensor for the optical moving target detection.

### (3) Moving Target Detection/Heterosource Video Fusion Reconnaissance Mode

The photoelectric radar comprehensive reconnaissance equipment is in an auxiliary GMTI mode, the platform in this mode is in a geographical tracking mode, and with the radar GMTI being turned on. A range of a detection distance set by a radar ground moving target detection mode is the same as a range of a detection distance set by the photoelectric sensor. The radar scans and outputs target plots and tracks, and the laser rangefinder turns on laser ranging to obtain precise geographical locations of four corners of the video. Geographical location information of any pixel in the video may be obtained according to positions of a center point and four corners of the video. The plots and tracks of the radar can be mapped to the video image according to the geographical location of the plots and track of the radar, and motion parameters (distance, speed) of the target can be displayed, and the information of the moving target in the photoelectric image is labelled, thus realizing the moving target detection/heterosource video fusion reconnaissance mode.

The photoelectric radar comprehensive reconnaissance equipment of the present disclosure is an aerial reconnaissance equipment that integrates photoelectric sensors and radar sensors. The radar is highly integrated with the optical imaging load and the laser rangefinder. It has capabilities of radar and optical reconnaissance information acquisition and laser irradiation in a single flight, giving full play to characteristics of a long reconnaissance distance of the radar and no impact from weather conditions, and complementing disadvantages of the optical image that are greatly affected by visibility and a short reconnaissance distance. At the same time, the optical image with close-distance reconnaissance information has characteristics of richer details and easier interpretation, effectively compensate for disadvantages of the radar image, such as, not conforming to human visual habits, difficulty in interpretation, and limitations in imaging modes, providing powerful and efficient reconnaissance capabilities for an unmanned aerial vehicle.

The present disclosure adopts the multi-source imaging reconnaissance mode to realize the fusion of radar and optical images, effectively improve effective information of a single picture, provide a basis for target detection, identification, and interpretation, and improve the reconnaissance efficiency. The present disclosure adopts the collaborative search reconnaissance mode to organically combine radar GMTI and optical moving target reconnaissance to improve a target detection rate and effectively improve a reconnaissance efficiency. The present disclosure adopts the moving target detection/heterosource video fusion reconnaissance mode, the plots and tracks of the radar GMTI is labeled on the optical video to improve readability of the moving target.

A system for photoelectric radar comprehensive reconnaissance includes an electronics cabin, a cantilever and a load cabin; the load cabin is installed on a side wall of the electronics cabin through the cantilever, and the load cabin is electrically coupled to the electronics cabin; the load cabin is provided with a visible light camera, an infrared thermal imager, a laser rangefinder and a radar therein; the electronics cabin is provided with an image processing module, a data processing module, an image fusion module, an image compression module and a platform control and driver module therein.

When the reconnaissance system is in a radar multi-source reconnaissance mode,
the visible light camera, performs image sampling, obtains a visible light image signal, and sends the visible light image signal to the image processing module;
the infrared thermal imager, performs image sampling, obtain an infrared image signal, and sends the infrared image signal to the image processing module;
the laser rangefinder, measures a distance value between the load cabin and a target, and sends the distance value to the image processing module;
the image processing module, receives the distance value from the laser rangefinder, receives the visible light image signal from the visible light camera, receives the infrared image signal from the infrared thermal imager, and performs geometric correction on the visible light image signal and the infrared image signal to generate a corrected optical image, and sends the corrected optical image to the image fusion module;
the radar, performs echo data sampling and sends echo data to the data processing module;
the data processing module, receives the echo data from the radar, converts the echo data into a radar image, performs geometric correction on the radar image to generate a corrected radar image, and sends the corrected radar image to the image fusion module, and obtains a load cabin adjustment angle according to the corrected radar image, and sends the load cabin adjustment angle to the platform drive module;
the platform control and drive module, receives the load cabin adjustment angle from the data processing module, and drives, according to the load cabin adjustment angle, the cantilever to rotate the load cabin to aim at the target;
the image fusion module, receives the corrected optical image from the image processing module, receives the corrected radar image from the data processing module, performs image registration and fusion processing on the corrected optical image and the corrected radar image in sequence, obtain an original image, and send the original image to the image compression module;
the image compression module, receives the original image from the image fusion module, compresses the original image, generates a compressed image, and downloads the compressed image to an external ground station.

In the above-mentioned system for photoelectric radar comprehensive reconnaissance, the electronics cabin is further provided with a geographical tracking unit, a tracking module and a moving target detection module.

When the reconnaissance system is in a collaborative search reconnaissance mode,
the radar, performs echo data sampling and sends echo data to the data processing module;
the data processing module, receives the echo data from the radar, performs parsing processing on the echo data, obtains plots and tracks data of a target, and sends the plots and tracks data of the target to the geographical tracking unit;
the geographic tracking unit, receives the plots and tracks data of the target from the data processing module, obtains a load cabin adjustment angle by parsing based on the plots and tracks data of the target and its own pose information, and sends the load cabin adjustment angle to the platform control and drive module;
the platform control and drive module, receives the load cabin adjustment angle from the geographical tracking unit, drives, according to the load cabin adjustment angle, the cantilever to rotate the load cabin to aim at the target, and receives a target miss angle from the tracking module, and drives, according to the target miss angle, the cantilever to rotate the load cabin, to aim at and track a target area, thus achieving collaborative search;
the moving target detection module, after receiving a moving target detection turning-on indication, measures a target offset and send the target offset to the tracking module;
the tracking module, receives the target offset from the moving target detection module, parsing the target offset to obtain the target miss angle, and sends the target miss angle to the platform control and drive module.

In the above-mentioned system for photoelectric radar comprehensive reconnaissance, when the reconnaissance system is in a moving target detection and heterosource video fusion reconnaissance mode,
the visible light camera, performs image sampling, obtains a visible light video signal, and sends the visible light video signal to the image processing module;
the infrared thermal imager, performs image sampling, obtains an infrared video signal, and sends the infrared video signal to the image processing module;
the laser rangefinder, measures a distance value between the load cabin and a target, and sends the distance value to the image processing module;
the image processing module, receives the distance value from the laser rangefinder, receives the visible light video signal from the visible light camera, receives the infrared video signal from the infrared thermal imager, positioning the visible light video signal and infrared video signal according to the distance value and its own pose information to obtain an optical video with positioning information, and send the optical video with positioning information to the image fusion module;
the radar, performs echo data sampling and sending echo data to the data processing module;
the data processing module, receives the echo data from the radar, performs echo data processing on the echo data, generates plots and tracks data of the target, and sends the plots and tracks data of the target to the image fusion module;
the image fusion module, receives the optical video with positioning information from the image processing module, receives the plots and tracks data from the data processing module, performs registration and fusion processing on the optical video with positioning information with the plots and tracks data, to obtain a video superimposed with moving target information, completing moving target detection and heterosource video fusion reconnaissance.

In the above-mentioned system for photoelectric radar comprehensive reconnaissance, the multi-source imaging reconnaissance mode refers to that a servo action of the cantilever is controlled by the radar, and the radar is in a strip mode, adjusts an optical field of view, and obtains an image of a target area for fusion.

In the above-mentioned system for photoelectric radar comprehensive reconnaissance, the cooperative search reconnaissance mode refers to that a load is first in a GMTI (ground moving target indication) operation mode, selects the target, guides photoelectric to point to the target, and detects and tracks the target.

In the above-mentioned system for photoelectric radar comprehensive reconnaissance, the moving target detection and heterosource video fusion reconnaissance mode is to label plots and tracks of the radar GMTI on the optical video to improve readability of the moving target.

In the above-mentioned system for photoelectric radar comprehensive reconnaissance, an optical axis parallelism of the visible light camera, the infrared thermal imager, and the laser rangefinder is calibrated and maintained within 0.2 mrad.

In the above-mentioned system for photoelectric radar comprehensive reconnaissance, a parallelism between a beam direction of the radar and a visual axis of the optical sensor is less than 0.5°, enabling acquisition of information in the same target area and performing the multi-source imaging reconnaissance, the collaborative search reconnaissance and the moving target detection and heterosource video fusion reconnaissance mode.

In the above-mentioned system for photoelectric radar comprehensive reconnaissance, characterized in that, the compressed image is in a format of JPEG.

Compared with the prior arts, beneficial effects of the present disclosure are as follows.
(1) The present disclosure adopts the multi-source imaging reconnaissance mode to realize fusion of the radar image and the optical image, effectively improve effective information of a single picture, provide a basis for target detection, identification, and interpretation, and improve a reconnaissance efficiency.
(2) The present disclosure adopts the collaborative search reconnaissance mode to organically combine the radar GMTI and optical moving target reconnaissance to improve a detection rate of the target and effectively improve the reconnaissance efficiency.
(3) The present disclosure adopts the moving target detection and heterosource video fusion reconnaissance mode to mark the plots and tracks of the radar GMTI on the optical video to improve the readability of the moving target.
(4) The present disclosure adopts the multi-source imaging reconnaissance mode, the collaborative search reconnaissance mode, the moving target detection and heterosource video fusion reconnaissance mode to realize complementary advantages of different reconnaissance means, and has reconnaissance support capabilities in all-day, all-weather and complex environments.

Although the present disclosure has been disclosed above in terms of preferred embodiments, they are not intended to limit the present disclosure. Any person skilled in the art can make possible variations and modifications to the technical solutions of the present disclosure based on the methods and technical content disclosed above, without departing from the spirit and scope of the present disclosure. Therefore, any simple modifications, equivalent changes and modifications made to the above embodiments based on the technical essence of the present disclosure, without departing from the content of the technical solution of the present disclosure, fall within the scope of protection of the technical solution of the present disclosure.

1. A system for photoelectric radar comprehensive reconnaissance, comprising an electronics cabin, a cantilever and a load cabin; the load cabin being installed on a side wall of the electronics cabin through the cantilever, and the load cabin is electrically coupled to the electronic cabin; the load cabin is provided with a visible light camera, an infrared thermal imager, a laser rangefinder and a radar therein; the electronics cabin is provided with an image processor, a data processor, an image fusion processor, an image compression processor and a platform control and driver processor therein;
when the system is in a radar multi-source reconnaissance mode,
the visible light camera, performs image sampling, obtains a visible light image signal, and sends the visible light image signal to the image processor;
the infrared thermal imager, performs image sampling, obtain an infrared image signal, and sends the infrared image signal to the image processor;
the laser rangefinder, measures a distance value between the load cabin and a target, and sends the distance value to the image processor;
the image processor, receives the distance value from the laser rangefinder, receives the visible light image signal from the visible light camera, receives the infrared image signal from the infrared thermal imager, and performs geometric correction on the visible light image signal and the infrared image signal to generate a corrected optical image, and sends the corrected optical image to the image fusion processor;
the radar, performs echo data sampling and sends echo data to the data processor;
the data processor, receives the echo data from the radar, converts the echo data into a radar image, performs geometric correction on the radar image to generate a corrected radar image, and sends the corrected radar image to the image fusion processor, and obtains a load cabin adjustment angle according to the corrected radar image, and sends the load cabin adjustment angle to the platform drive processor;
the platform control and drive processor, receives the load cabin adjustment angle from the data processor, and drives, according to the load cabin adjustment angle, the cantilever to rotate the load cabin to aim at the target;
the image fusion processor, receives the corrected optical image from the image processor, receives the corrected radar image from the data processor, performs image registration and fusion processing on the corrected optical image and the corrected radar image in sequence, obtain an original image, and send the original image to the image compression processor;
the image compression processor, receives the original image from the image fusion processor, compresses the original image, generates a compressed image, and downloads the compressed image to an external ground station.

2. The system according to claim 1, wherein the electronics cabin is further provided with a geographical tracking processor, a tracking processor and a moving target detection processor;
when the reconnaissance system is in a collaborative search reconnaissance mode,
the radar, performs echo data sampling and sends echo data to the data processor;
the data processor, receives the echo data from the radar, performs parsing processing on the echo data, obtains plots and tracks data of a target, and sends the plots and tracks data of the target to the geographical tracking processor;
the geographic tracking processor, receives the plots and tracks data of the target from the data processor, obtains a load cabin adjustment angle by parsing based on the plots and tracks data of the target and its own pose information, and sends the load cabin adjustment angle to the platform control and drive processor,
the platform control and drive processor, receives the load cabin adjustment angle from the geographical tracking processor, drives, according to the load cabin adjustment angle, the cantilever to rotate the load cabin to aim at the target, and receives a target miss angle from the tracking processor, and drives, according to the target miss angle, the cantilever to rotate the load cabin, to aim at and track a target area, thus achieving collaborative search;
the moving target detection processor, after receiving a moving target detection turning-on indication, measures a target offset and send the target offset to the tracking processor;
the tracking processor, receives the target offset from the moving target detection processor, parsing the target offset to obtain the target miss angle, and sends the target miss angle to the platform control and drive processor.

3. The system according to claim 2, wherein when the reconnaissance system is in a moving target detection and heterosource video fusion reconnaissance mode,
the visible light camera, performs image sampling, obtains a visible light video signal, and sends the visible light video signal to the image processor;
the infrared thermal imager, performs image sampling, obtains an infrared video signal, and sends the infrared video signal to the image processor;
the laser rangefinder, measures a distance value between the load cabin and a target, and sends the distance value to the image processor;
the image processor, receives the distance value from the laser rangefinder, receives the visible light video signal from the visible light camera, receives the infrared video signal from the infrared thermal imager, positioning the visible light video signal and infrared video signal according to the distance value and its own pose information to obtain an optical video with positioning information, and send the optical video with positioning information to the image fusion processor;
the radar, performs echo data sampling and sending echo data to the data processor;
the data processor, receives the echo data from the radar, performs echo data processing on the echo data, generates plots and tracks data of the target, and sends the plots and tracks data of the target to the image fusion processor;
the image fusion processor, receives the optical video with positioning information from the image processor, receives the plots and tracks data from the data processor, performs registration and fusion processing on the optical video with positioning information with the plots and tracks data, to obtain a video superimposed with moving target information, completing moving target detection and heterosource video fusion reconnaissance.

4. The system according to claim 1, wherein the multi-source imaging reconnaissance mode refers to that a servo action of the cantilever is controlled by the radar, and the radar is in a strip mode, adjusts an optical field of view, and obtains an image of a target area for fusion.

5. The system according to claim 2, wherein the cooperative search reconnaissance mode refers to that a load is first in a GMTI (ground moving target indication) operation mode, selects the target, guides photoelectric to point to the target, and detects and tracks the target.

6. The system according to claim 3, wherein the moving target detection and heterosource video fusion reconnaissance mode is to label plots and tracks of a radar GMTI on the optical video to improve readability of the moving target.

7. The system according to claim 1, wherein an optical axis parallelism of the visible light camera, the infrared thermal imager, and the laser rangefinder is calibrated and maintained within 0.2 mrad.

8. The system according to claim 7, wherein a parallelism between a beam direction of the radar and a visual axis of the optical sensor is less than 0.5°, enabling acquisition of information in the same target area and performing the multi-source imaging reconnaissance, the collaborative search reconnaissance and the moving target detection and heterosource video fusion reconnaissance mode.

9. The system according to claim 1, wherein the compressed image is in a format of JPEG.
